(19) United States
(12) Patent Application Publication
(10) Pub. No.: US 2018/0279701 A1
(43) Pub. Date: Oct. 4, 2018

(54) PROTECTIVE GLOVES FOR USE WITH NAIL GUNS, STAPLE GUNS AND THE LIKE

(71) Applicant: Superior Glove Works Limited, Acton (CA)

(72) Inventors: William Brierley, Acton (CA); Jim Gruener, Mooresville, IN (US)

(21) Appl. No.: 15/903,018

(22) Filed: Feb. 22, 2018

Related U.S. Application Data
(60) Provisional application No. 62/481,115, filed on Apr. 3, 2017.

(51) Int. Cl. A41D 19/015; A41D 31/00; A41D 19/00

(52) U.S. Cl. CPC A41D 19/01505; A41D 31/0005; B32B 5/02; A41D 2600/20; A41D 2300/324; A41D 19/001

(57) ABSTRACT

A protective glove includes a series of armor plates positioned on the glove to protect the portions of the hand that are typically exposed to nail impacts when using a nail gun, while leaving other portions of the glove uncovered so as to preserve freedom of movement. The glove includes a main portion having a wrist opening for inserting a human hand, an index finger portion extending from the main portion and a thumb portion extending from the main portion. A plurality of articulated armor plates is disposed at least along a radial surface of the main portion, a radial surface of the index finger portion and a radial surface of the thumb portion to protect those surfaces.

### CROSS-REFERENCE TO RELATED APPLICATION

This application claims priority to U.S. Provisional Application No. 62/481,115 filed Apr. 3, 2017, the teachings of which are hereby incorporated by reference.

### TECHNICAL FIELD

The present disclosure relates to gloves, and more particularly to protective gloves.

### BACKGROUND

A nail gun is a tool that is used to drive nails into a desired material, such as wood. A staple gun is similarly used to drive staples. Hand injuries from nail guns and staple guns are common and can be quite severe, but because these devices drive the nails/staples with considerable force, the nails/staples can penetrate many types of common protective gloves.

### SUMMARY

Broadly speaking, the present disclosure is directed to a protective glove which includes a main portion having a wrist opening for inserting a human hand, an index finger portion extending from the main portion and a thumb portion extending from the main portion, and which has a plurality of articulated armor plates disposed at least along a radial surface of the main portion, a radial surface of the index finger portion and a radial surface of the thumb portion. Preferably, the armor plates leave at least fifty percent of an outer surface of the glove exposed, and the armor plates may curve dorsally to cover at least a radial side of a dorsal surface of the main portion, a radial side of a dorsal surface of the index finger portion and a radial side of a dorsal surface of the thumb portion. The index finger portion may be one of four finger portions extending from the main portion.

In one aspect, a protective glove comprises a flexible base glove adapted to fit over a human hand and including a main portion corresponding in position to human metacarpal bones of the human hand and having a wrist opening for inserting the human hand, at least an index finger portion extending from the main portion and a thumb portion extending from the main portion. The index finger portion corresponds to an index finger of the human hand, and includes at least an index finger proximal phalanx portion and an index finger middle phalanx portion corresponding in position to an index finger proximal phalanx and an index finger middle phalanx, respectively, of the human hand. The thumb portion corresponds to a thumb of the human hand, and includes a thumb proximal phalanx portion and a thumb distal phalanx portion corresponding in position to a thumb proximal phalanx and a thumb distal phalanx, respectively, of the human hand. A plurality of discrete armor plates are secured on the base glove. The armor plates are positioned on the base glove to cover at least a radial surface of the index finger proximal phalanx portion, the index finger middle phalanx portion, the thumb proximal phalanx portion, the thumb distal phalanx portion, an index finger metacarpal portion of the main portion corresponding in position to a human index finger metacarpal bone of the human hand and a thumb metacarpal portion of the main portion corresponding in position to a human thumb metacarpal bone of the human hand.

In one embodiment, the base glove includes middle, ring and little finger portions and the armor plates leave the middle, ring and little finger portions uncovered. In another embodiment, the main portion of the base glove has at least one distal finger aperture through which middle, ring and little fingers may pass. In one particular embodiment, the main portion of the base glove is of open construction adapted to wrap around a wearer's hand and is provided with adjustable straps for securing the main portion in a wrapped configuration and, when in the wrapped configuration, the main portion of the base glove forms the wrist opening and further forms a single distal finger aperture opposite the wrist opening and through which middle, ring and little fingers may pass.

In some embodiments, the armor plates comprise an index finger metacarpal plate positioned on the base glove to cover at least the radial surface of the index finger metacarpal portion, an index finger proximal phalanx plate positioned on the base glove to cover at least the radial surface of the index finger proximal phalanx portion, an index finger middle phalanx plate positioned on the base glove to cover at least the radial surface of the index finger middle phalanx portion, a thumb metacarpal plate positioned on the base glove to cover at least the radial surface of the thumb metacarpal portion, a thumb proximal phalanx plate positioned on the base glove to cover at least the radial surface of the thumb proximal phalanx portion and a thumb distal phalanx plate positioned on the base glove to cover at least the radial surface of the thumb distal phalanx portion.

The index finger metacarpal plate and the index finger proximal phalanx plate may be spaced apart from one another on either side of an index finger metacarpophalangeal joint portion of the base glove corresponding in position to a human index finger metacarpophalangeal joint. The index finger proximal phalanx plate and the index finger middle phalanx plate may be spaced apart from one another on either side of an index finger proximal interphalangeal joint portion of the base glove corresponding in position to a human index finger proximal interphalangeal joint. The thumb metacarpal plate and the thumb proximal phalanx plate may be spaced apart from one another on either side of a thumb metacarpophalangeal joint portion of the base glove corresponding in position to a thumb metacarpophalangeal joint. The thumb proximal phalanx plate and the thumb distal phalanx plate may be spaced apart from one another on either side of a thumb interphalangeal joint portion of the base glove corresponding in position to a thumb interphalangeal joint.

In some embodiments, the armor plates further comprise an index finger metacarpophalangeal joint plate secured on the base glove at the index finger metacarpophalangeal joint portion thereof to cover at least the radial surface of the index finger metacarpophalangeal joint portion, an index finger proximal interphalangeal joint plate secured on the base glove at the index finger proximal interphalangeal joint portion thereof to cover at least the radial surface of the index finger proximal interphalangeal joint portion, a thumb metacarpophalangeal joint plate secured on the base glove at the thumb metacarpophalangeal joint portion thereof to cover at least the radial surface of the thumb metacarpophalangeal joint portion, and a thumb interphalangeal joint plate secured on the base glove at the thumb interphalangeal joint portion thereof to cover at least the radial surface of the index finger metacarpophalangeal joint plate, the index finger proximal interphalangeal joint plate, the thumb metacarpophalangeal joint plate and the thumb interphalangeal joint plate are discrete plates. In some such embodiments, the index finger metacarpophalangeal joint plate may overlap the index finger proximal phalanx plate and the index finger metacarpal plate, the index finger proximal interphalangeal joint plate may overlap the index finger proximal phalanx plate and the index finger middle phalanx plate, the thumb metacarpophalangeal joint plate may overlap the thumb proximal phalanx plate and the thumb metacarpal plate and the thumb interphalangeal joint plate may overlap the thumb proximal phalanx plate and the thumb distal phalanx plate. In some particular embodiments, the index finger metacarpophalangeal joint plate may be secured to the index finger metacarpal plate, the index finger proximal interphalangeal joint plate may be secured to the index finger proximal phalanx plate, the thumb metacarpophalangeal joint plate may be secured to the thumb metacarpal plate and the thumb interphalangeal joint plate may be secured to the thumb proximal phalanx plate. In other embodiments, the index finger metacarpophalangeal joint plate may be formed monolithically with the index finger metacarpal plate and extend distally therefrom to overlap the index finger proximal phalanx plate, the index finger proximal interphalangeal joint plate may be formed monolithically with the index finger proximal phalanx plate and extend distally therefrom to overlap the index finger middle phalanx plate, the thumb metacarpophalangeal joint plate may be formed monolithically with the thumb metacarpal plate and extend distally therefrom to overlap the thumb proximal phalanx plate and the thumb interphalangeal joint plate may be formed monolithically with the thumb proximal phalanx plate and extend distally therefrom to overlap the thumb distal phalanx plate.

The protective glove may further comprise a carpal plate positioned on the base glove to cover at least a radial surface of a carpal portion of the main body of the base glove corresponding in position to a human carpal bone assembly, with the carpal plate and the index finger metacarpal plate being spaced apart from one another on either side of an index finger carpometacarpal joint portion of the base glove corresponding in position to a human index finger carpometacarpal joint. The carpal plate may extend proximally beyond the carpal portion of the main body of the base glove. A carpometacarpal joint plate may be secured on the base glove at the index finger carpometacarpal joint portion thereof to cover at least the radial surface of the index finger carpometacarpal joint portion. In some embodiments, the carpometacarpal joint plate may be a discrete plate that overlaps the carpal plate and the index finger metacarpal plate; in such embodiments the carpometacarpal joint plate may be secured to the index finger metacarpal plate. In other embodiments, the carpometacarpal joint plate may be formed integrally with the index finger metacarpal plate and extend proximally therefrom to overlap the carpal plate.

In some embodiments, the thumb metacarpal plate may overlap the carpal plate, and the carpometacarpal joint plate may further overlap the thumb metacarpal plate.

In some embodiments, the index finger proximal phalanx plate, the index finger middle phalanx plate, the thumb proximal phalanx plate, the thumb distal phalanx plate, the index finger metacarpal plate, the thumb metacarpal plate, the index finger proximal interphalangeal joint plate, the index finger metacarpophalangeal joint plate, the thumb interphalangeal joint plate, the thumb metacarpophalangeal joint plate, the carpal plate and the carpometacarpal joint plate may be curved to accommodate curvature of the human hand. In certain particular embodiments, the index finger proximal phalanx plate may curve dorsally to cover a radial side of a dorsal surface of the index finger proximal phalanx portion of the base glove, the index finger middle phalanx plate may curve dorsally to cover a radial side of a dorsal surface of the index finger middle phalanx portion of the base glove, the thumb proximal phalanx plate may curve dorsally to cover a radial side of a dorsal surface of the thumb proximal phalanx portion of the base glove and the thumb distal phalanx plate may curve dorsally to cover a radial side of a dorsal surface of the thumb distal phalanx portion of the base glove. The index finger metacarpal plate may curve dorsally to cover a radial side of a dorsal surface of the index finger metacarpal portion of the base glove and the thumb metacarpal plate may curve dorsally to cover a radial side of a dorsal surface of the thumb metacarpal portion of the base glove. The index finger proximal interphalangeal joint plate may curve dorsally to cover a radial side of a dorsal surface of the index finger proximal interphalangeal joint portion of the base glove, the index finger metacarpophalangeal joint plate may curve dorsally to cover a radial side of a dorsal surface of the index finger metacarpophalangeal joint portion of the base glove, the thumb interphalangeal joint plate may curve dorsally to cover a radial side of a dorsal surface of the thumb interphalangeal joint portion of the base glove and the thumb metacarpophalangeal joint plate may curve dorsally to cover a radial side of a dorsal surface of the thumb metacarpophalangeal joint portion of the base glove. The carpal plate may curve dorsally to cover a radial side of a dorsal surface of the carpal portion of the base glove and the carpometacarpal joint plate may curve dorsally to cover a radial side of a dorsal surface of the carpometacarpal joint portion of the base glove.

In certain preferred embodiments, the index finger portion of the base glove further comprises an index finger distal interphalangeal joint portion corresponding in position to an index finger distal interphalangeal joint of a human hand and an index finger distal phalange portion corresponding in position to an index finger distal phalange of a human hand, and the index finger middle phalanx plate extends distally beyond the index finger distal interphalangeal joint portion to cover at least a radial surface of a proximal end of the distal phalange portion.

Preferably, the armor plates leave at least fifty percent of an outer surface of the base glove uncovered. More preferably, the armor plates leave at least sixty percent of an outer surface of the base glove uncovered, and still more preferably, the armor plates leave at least seventy percent of an outer surface of the base glove uncovered.

### BRIEF DESCRIPTION OF THE DRAWINGS

These and other features will become more apparent from the following description in which reference is made to the appended drawings wherein:

FIG. 1 shows a radial side of a human hand wearing a first exemplary protective glove according to an aspect of the present disclosure, with the hand in a partially closed configuration and bones of the hand shown with dashed lines;

FIG. 2 shows the radial side of the human hand and protective glove of FIG. 1, with the hand in an open configuration and bones of the hand shown with dashed lines;

FIG. 3 is a palmar perspective view of the human hand and protective glove of FIG. 1, with the hand in an open configuration and bones of the hand shown with dashed lines;

FIG. 4 is a dorsal perspective view of the human hand and protective glove of FIG. 1, with the hand in an open configuration and bones of the hand shown with dashed lines;

FIG. 5 shows a radial side of a human hand wearing a second exemplary protective glove according to an aspect of the present disclosure, with the hand in a partially closed configuration and bones of the hand shown with dashed lines;

FIG. 6 shows the radial side of the human hand and protective glove of FIG. 5, with the hand in an open configuration and bones of the hand shown with dashed lines;

FIG. 7 is a palmar perspective view of the human hand and protective glove of FIG. 5, with the hand in an open configuration and bones of the hand shown with dashed lines;

FIG. 8 is a dorsal perspective view of the human hand and protective glove of FIG. 5, with the hand in an open configuration and bones of the hand shown with dashed lines;

FIG. 9 shows a radial side of a human hand wearing a third exemplary protective glove according to an aspect of the present disclosure, with the hand in a partially closed configuration and bones of the hand shown with dashed lines;

FIG. 10 shows the radial side of the human hand and protective glove of FIG. 9, with the hand in an open configuration and bones of the hand shown with dashed lines;

FIG. 11 is a palmar perspective view of the human hand and protective glove of FIG. 9, with the hand in an open configuration and bones of the hand shown with dashed lines;

FIG. 12 is a dorsal perspective view of the human hand and protective glove of FIG. 9, with the hand in an open configuration and bones of the hand shown with dashed lines;

FIG. 13 shows a radial side of a human hand wearing a fourth exemplary protective glove according to an aspect of the present disclosure, with the hand in a partially closed configuration and bones of the hand shown with dashed lines;

FIG. 14 shows the radial side of the human hand and protective glove of FIG. 13, with the hand in an open configuration and bones of the hand shown with dashed lines;

FIG. 15 is a palmar perspective view of the human hand and protective glove of FIG. 13, with the hand in an open configuration and bones of the hand shown with dashed lines;

FIG. 16 is a dorsal perspective view of the human hand and protective glove of FIG. 13, with the hand in an open configuration and bones of the hand shown with dashed lines; and

FIG. 17 shows the radial side of the protective glove of FIG. 13 in 400 in a flattened, unrolled configuration with its armor plates dismounted.

### DETAILED DESCRIPTION

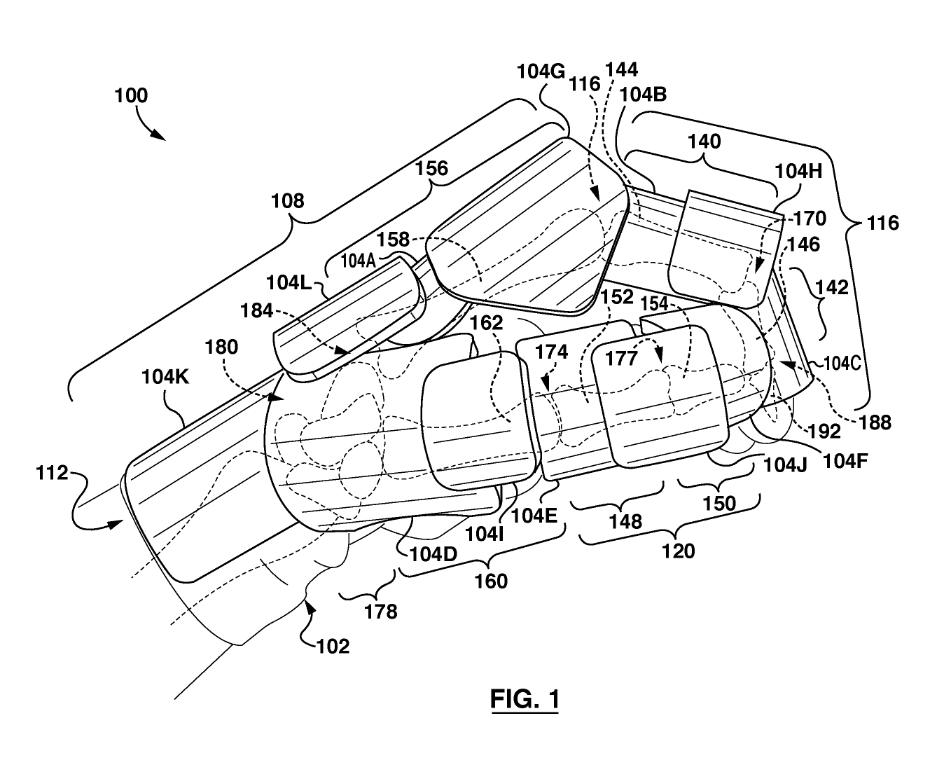

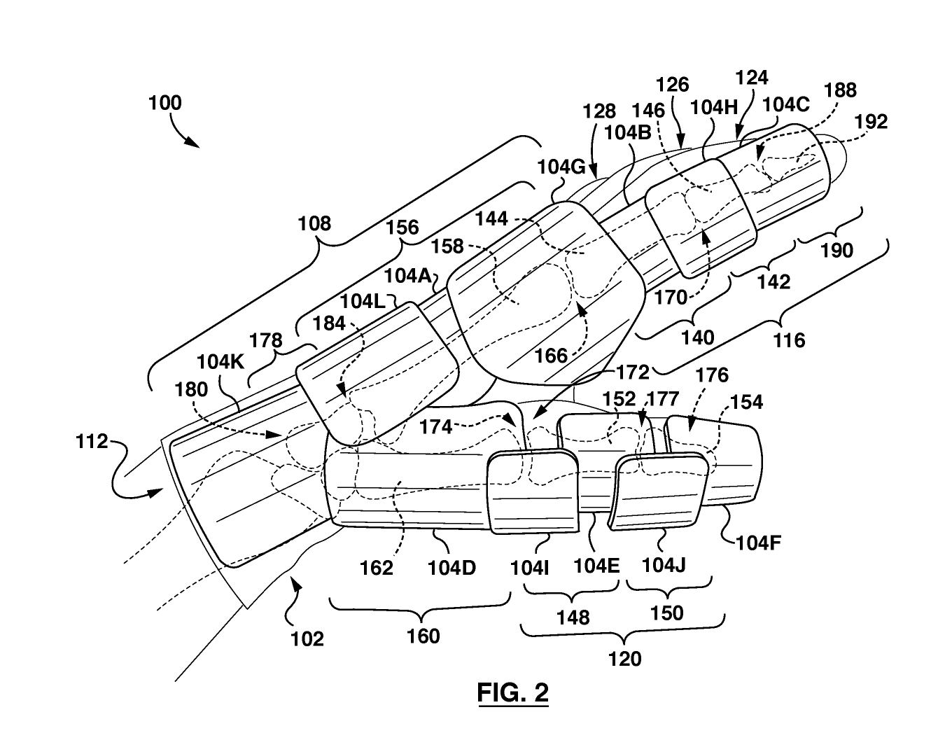

Reference is now made to FIGS. 1 to 4, in which a first exemplary protective glove is indicated generally at reference 100. The protective glove 100 comprises a flexible base glove 102 and a plurality of discrete, rigid armor plates 104A to 104L secured on the base glove 102. The armor plates 104A to 104L may be secured on the base glove 102 using any suitable technique, such as adhesive. For example, and without limitation, 3M™ Nitrile High Performance Adhesive 1099 may be used. Alternatively, riveting or stitching may be used (e.g. the plates 104A to 104L may be formed with holes for riveting or stitching). In some embodiments, as described further below, snap fasteners may be used to allow the armor plates to be selectively mounted on and dismounted from the base glove.

The base glove 102 is adapted to fit over a human hand, the bones of which are shown in dashed lines in the Figures, and may be made of any suitable material(s) using any suitable type of construction. For example, the base glove 102 may be a knit glove, or may be formed from one or more discrete pieces of material stitched or otherwise secured to one another according to any suitable glove pattern, and may have, for example, a straight thumb, a wing thumb, a keystone thumb or choy thumb. Moreover, all or part of the base glove 102 may be formed from one or more layers of materials (including coatings such as polyurethane), and may include cut-resistant and/or penetration resistant materials, including composite filament fibers. For example, and without limitation, composite filament fibers used with the base glove 102 may be 400 Denier F/G Sheath, 4 Black Poly Silvers, 40 Denier SF Lycra. In one embodiment, the base glove 102 may be a cut-resistant knit glove of the type sold as model S13TAFNT under the trademark TenActiv™ by Superior Glove Works Ltd., having an address at 36 Vimy Street, Acton, ON, Canada, L7J 1S1.

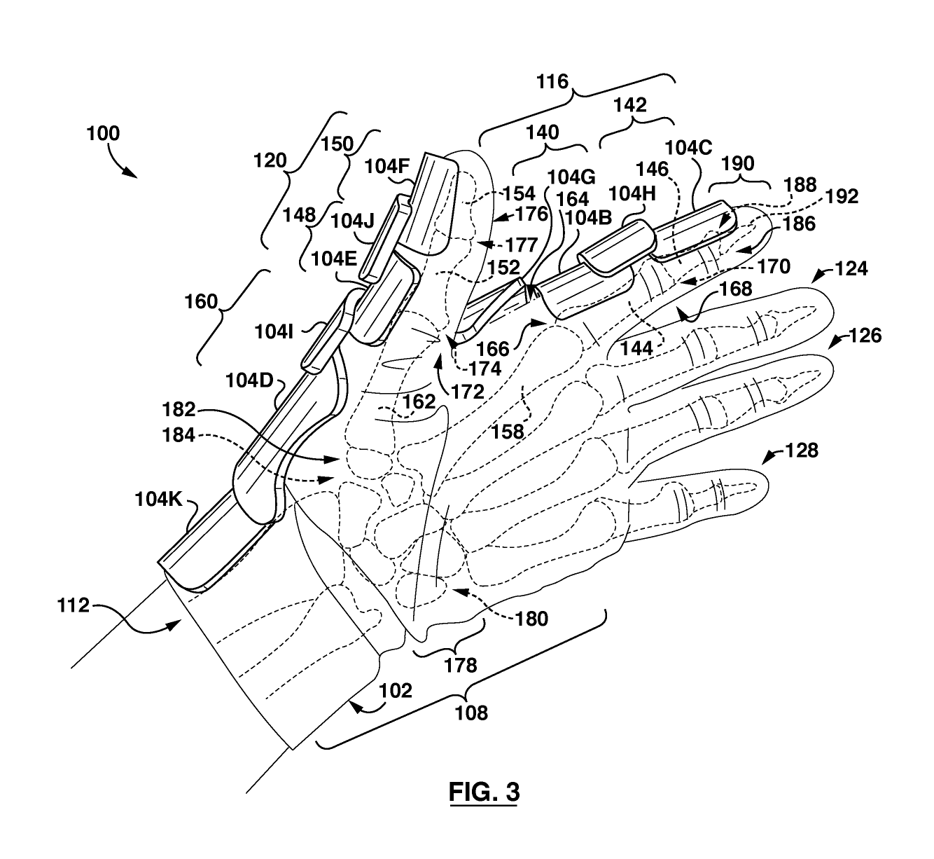

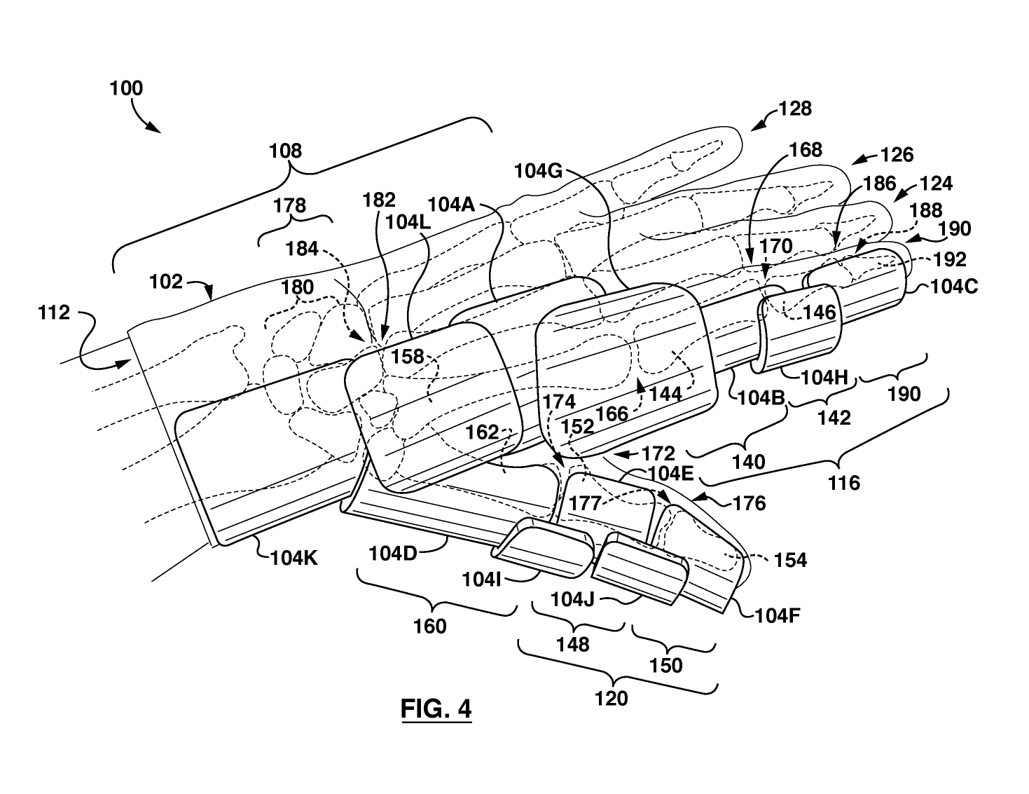

The base glove 102 includes a main portion 108 corresponding in position to at least metacarpal bones of the human hand and having a wrist opening 112 for inserting the human hand; the wrist opening 112 corresponds generally in position to the human wrist, and may include a cuff. The base glove 102 includes an index finger portion 116 extending from the main portion 108 and corresponding to an index finger of the human hand, as well as a thumb portion 120, also extending from the main portion 108 and corresponding to a thumb of the human hand. In the first exemplary protective glove 100, as best seen in FIGS. 3 and 4, the base glove 102 also includes middle, ring and little finger portions 124, 126, 128, respectively, corresponding to middle, ring and little fingers of the human hand. In other embodiments, the base glove may not include middle, ring and little finger portions and instead apertures may be formed in the main portion through which the middle, ring and little fingers may pass, i.e. a “hand cap” variant of the glove.

The index finger portion 116 of the base glove 102 includes at least an index finger proximal phalanx portion 140 and an index finger middle phalanx portion 142 corresponding in position to an index finger proximal phalanx 144 and an index finger middle phalanx 146, respectively, of the human hand. Similarly, the thumb portion 120 includes a thumb proximal phalanx portion 148 and a thumb distal phalanx portion 150 corresponding in position to a thumb proximal phalanx 152 and a thumb distal phalanx 154, respectively, of the human hand.

The armor plates 104A to 104L are positioned on the base glove 102 to cover the radial surface of the index finger proximal phalanx portion 140, the index finger middle phalanx portion 142, the thumb proximal phalanx portion 148 and the thumb distal phalanx portion 150, as well as an index finger metacarpal portion 156 of the main portion 102, corresponding in position to a human index finger metacarpal bone 158 of the human hand, and a thumb metacarpal portion 160 of the main portion 102, corresponding in position to a human thumb metacarpal bone 162 of the human hand. The armor plates 104A to 104L may be made from any suitable material, including (by way of example and not limitation) aramid such as that marketed under the trademark Kevlar®, or a suitable lightweight metal, and are preferably of sufficient thickness, given the material used, to withstand the impact force generated by a 4.8 gram steel nail travelling at 1000 feet per second (about 304.8 meters per second) so as to prevent penetration by a nail expelled from a nail gun at close range. Optionally, impact foam (not shown) may be disposed on the sides of the armor plates 104A to 104L that face the base glove 102 to cushion the impact from a nail or staple.

Certain exemplary and non-limiting arrangements of armor plates will now be described.

In the first exemplary protective glove 100, an index finger metacarpal plate 104A is positioned on the base glove 102 to cover at least a major portion of the radial surface of the index finger metacarpal portion 156, an index finger proximal phalanx plate 104B is positioned on the base glove 102 to cover at least a major portion of the radial surface of the index finger proximal phalanx portion 140 and an index finger middle phalanx plate 104C is positioned on the base glove 102 to cover at least a major portion of the radial surface of the index finger middle phalanx portion 142. Similarly, in the first exemplary protective glove 100, a thumb metacarpal plate 104D is positioned on the base glove 102 to cover at least a major portion of the radial surface of the thumb metacarpal portion 160, a thumb proximal phalanx plate 104E is positioned on the base glove 102 to cover at least a major portion of the radial surface of the thumb proximal phalanx portion 148 and a thumb distal phalanx plate 104F is positioned on the base glove to cover at least a major portion of the radial surface of the thumb distal phalanx portion 150.

In the first exemplary protective glove 100, the armor plates 104A to 104L are spaced from one another to allow a hand within the protective glove 100 to articulate. Thus, the index finger metacarpal plate 104A and the index finger proximal phalanx plate 104B are spaced apart from one another on either side of an index finger metacarpophalangeal joint portion 164 (FIG. 3) of the base glove 102 corresponding in position to a human index finger metacarpophalangeal joint 166 and the index finger proximal phalanx plate 104B and the index finger middle phalanx plate 104C are spaced apart from one another on either side of an index finger proximal interphalangeal joint portion 168 (FIGS. 3 and 4) of the base glove 102 corresponding in position to a human index finger proximal interphalangeal joint 170. Likewise, the thumb metacarpal plate 104D and the thumb proximal phalanx plate 104E are spaced apart from one another on either side of a thumb metacarpophalangeal joint portion 172 (FIG. 3) of the base glove 102 corresponding in position to a thumb metacarpophalangeal joint 174 and the thumb proximal phalanx plate 104E and the thumb distal phalanx plate 104F are spaced apart from one another on either side of a thumb interphalangeal joint portion 176 of the base glove 102 corresponding in position to a thumb interphalangeal joint 177.

In order to provide protection at the interphalangeal joint portions 164, 168, 172, 176, in the illustrated embodiments, the armor plates on the protective glove 100 include joint plates which overlap the adjacent armor plates on either side. An index finger metacarpophalangeal joint plate 104G is secured on the base glove 102 at the index finger metacarpophalangeal joint portion 164 thereof to cover the radial surface of the index finger metacarpophalangeal joint portion 164. The index finger metacarpophalangeal joint plate 104G overlaps the index finger proximal phalanx plate 104B and the index finger metacarpal plate 104A. An index finger proximal interphalangeal joint plate 104H is secured on the base glove at the index finger proximal interphalangeal joint portion 168 thereof to cover the radial surface of the index finger proximal interphalangeal joint portion 168. The index finger proximal interphalangeal joint plate 104H overlaps the index finger proximal phalanx plate 104B and the index finger middle phalanx plate 104C. A thumb metacarpophalangeal joint plate 104I is secured on the base glove 102 at the thumb metacarpophalangeal joint portion 172 thereof to cover the radial surface of the thumb metacarpophalangeal joint portion 172. The thumb metacarpophalangeal joint plate 104I overlaps the thumb proximal phalanx plate 104E and the thumb metacarpal plate 104D. A thumb interphalangeal joint plate 104J is secured on the base glove 102 at the thumb interphalangeal joint portion 176 thereof to cover the radial surface of the thumb interphalangeal joint portion 176. The thumb interphalangeal joint plate 104J overlaps the thumb proximal phalanx plate 104E and the thumb distal phalanx plate 104F.

In the first exemplary protective glove 100, the joint plates 104G, 104H, 104I and 104I are discrete plates; i.e. separate and distinct from the other plates 104A to 104F and 104K. In other embodiments some or all of the joint plates may be combined with other plates, e.g. formed monolithically therewith.

The first exemplary protective glove 100 further comprises a carpal plate 104K positioned on the base glove 102 to cover at least the radial surface of a carpal portion 178 of the main portion 108 of the base glove 102. The carpal portion 178 of the main portion 108 of the base glove 102 corresponds in position to a human carpal bone assembly 180, and the carpal plate 104K and the index finger metacarpal plate 104A are spaced apart from one another on either side of an index finger carpometacarpal joint portion 182 (FIG. 4) of the base glove 102 corresponding in position to a human index finger carpometacarpal joint 184. The exemplary illustrated protective glove 100 further comprises a carpometacarpal joint plate 104L secured on the base glove 102 at the index finger carpometacarpal joint portion 182 thereof to cover the radial surface of the index finger carpometacarpal joint portion 182. The carpometacarpal joint plate 104L overlaps the carpal plate 104K and the index finger metacarpal plate 104A. The carpal plate 104K extends proximally (i.e. away from the index finger portion 116) beyond the carpal portion 178 of the main portion 108 of the base glove 102. Also, the thumb metacarpal plate 104D overlaps the carpal plate 104K and the carpometacarpal joint plate 104L further overlaps the thumb metacarpal plate 104D.

As can be seen from the above description, in certain preferred embodiments the armor plates 104A to 104L are arranged in a series in which adjacent armor plates overlap so as to provide articulation without gaps in coverage. In the first exemplary protective glove 100, the index finger metacarpophalangeal joint plate 104G is secured to the index finger metacarpal plate 104A, the index finger proximal interphalangeal joint plate 104H is secured to the index finger proximal phalanx plate 104B, the thumb metacarpophalangeal joint plate 104I is secured to the thumb metacarpal plate 104D and the thumb interphalangeal joint plate 104J is secured to the thumb proximal phalanx plate 104E. Additionally, the carpometacarpal joint plate 104L is secured to the carpal plate 104K. In the first exemplary protective glove 100, the joint plates 104G, 104H, 104I, 104J, 104L are fixed to the respective underlying plates 104A, 104B, 104D, 104E and 104 K, for example by adhesive; alternatively the joint plates may be secured to the underlying plates by hinges or pivot pins so as to permit the joint plates to pivot relative to the underlying plates without translation. In yet further embodiments, all of the plates may be secured directly to the base glove (e.g. the joint plates may include a pedestal extending between the underlying plates and secured to the base glove).

In the first exemplary protective glove 100, the index finger portion 116 of the base glove 102 further comprises an index finger distal interphalangeal joint portion 186 (FIGS. 3 and 4) corresponding in position to an index finger distal interphalangeal joint 188 of a human hand and an index finger distal phalange portion 190 (FIGS. 3 and 4) corresponding in position to an index finger distal phalange 192 of a human hand. In the illustrated embodiments, the index finger middle phalanx plate 104C extends distally beyond the index finger distal interphalangeal joint portion 186 to cover the radial surface of the proximal end of the index finger distal phalange portion 190; in other embodiments a separate index finger distal phalange plate and index finger distal interphalangeal joint may be provided.

While armor plates having a generally planar surface are within contemplation, preferably the armor plates are curved to accommodate curvature of the human hand. Thus, in the first exemplary protective glove 100, the index finger proximal phalanx plate 104B, the index finger middle phalanx plate 104C, the thumb proximal phalanx plate 104E, the thumb distal phalanx plate 104F, the index finger metacarpal plate 104A, the thumb metacarpal plate 104D, the index finger metacarpophalangeal joint plate 104G, the index finger proximal interphalangeal joint plate 104H, the thumb metacarpophalangeal joint plate 104I, the thumb interphalangeal joint plate 104I, the carpal plate 104K and the carpometacarpal joint plate 104L are curved to accommodate curvature of the human hand.

More particularly, in the first exemplary protective glove 100 the index finger proximal phalanx plate 104B curves dorsally to cover the radial side of the dorsal surface of the index finger proximal phalanx portion 140 of the base glove 102, the index finger middle phalanx plate 104C curves dorsally to cover the radial side of the dorsal surface of the index finger middle phalanx portion 142 of the base glove 102, the thumb proximal phalanx plate 104E curves dorsally to cover the radial side of the dorsal surface of the thumb proximal phalanx portion 148 of the base glove 102 and the thumb distal phalanx plate 104F curves dorsally to cover the radial side of the dorsal surface of the thumb distal phalanx portion 150 of the base glove 102. Similarly, the index finger metacarpal plate 104A curves dorsally to cover the radial side of the dorsal surface of the index finger metacarpal portion 156 of the base glove 102 and the thumb metacarpal plate 104D curves dorsally to cover the radial side of the dorsal surface of the thumb metacarpal portion 160 of the base glove 102.

Likewise, the index finger metacarpophalangeal joint plate 104G curves dorsally to cover the radial side of the dorsal surface of the index finger metacarpophalangeal joint portion 164 of the base glove 102 and the index finger proximal interphalangeal joint plate 104H curves dorsally to cover the radial side of the dorsal surface of the index finger proximal interphalangeal joint portion 168 of the base glove 102. Similarly, the thumb metacarpophalangeal joint plate 104I curves dorsally to cover the radial side of the dorsal surface of the thumb metacarpophalangeal joint portion 170 of the base glove 102 and the thumb interphalangeal joint plate 104I curves dorsally to cover a radial side of a dorsal surface of the thumb interphalangeal joint portion 174 of the base glove 102.

Additionally, the carpal plate 104K curves dorsally to cover the radial side of the dorsal surface of the carpal portion 178 of the base glove 102 and the carpometacarpal joint plate 104L curves dorsally to cover the radial side of the dorsal surface of the carpometacarpal joint portion 182 of the base glove 102.

Thus, as described above with reference to certain exemplary embodiments, the present disclosure is directed to a protective glove which includes a main portion having a wrist opening for inserting a human hand, an index finger portion extending from the main portion and a thumb portion extending from the main portion, and which has a plurality of articulated armor plates disposed at least along a radial surface of the main portion, a radial surface of the index finger portion and a radial surface of the thumb portion. The armor plates are positioned on the glove to protect the portions of the glove (and hence the hand) that are typically exposed to nail impacts when using a nail gun or staple impacts when using a staple gun, while leaving other portions of the glove uncovered so as to preserve freedom of movement.

In the first exemplary protective glove 100, as can be seen in FIGS. 3 and 4, the armor plates 104A to 104L leave the middle, ring and little finger portions 124, 126, 128, respectively, uncovered, and also leave the central dorsal and palmar regions of the main portion 108 and the ulnar side of the main portion 108 uncovered. Preferably, the armor plates 104A to 104L leave at least 50 percent, more preferably at least 60 percent and still more preferably at least 70 percent of the outer surface of the base glove 102 uncovered. Generally, leaving a greater percentage of the outer surface of the base glove 102 uncovered will result in a greater freedom of movement for the wearer while still providing protection against nail gun impacts.

When using a nail gun, a user's free hand is typically oriented so that the radial surfaces of the index finger, thumb and carpal portions of the hand face toward the direction of nail travel, with the middle, ring and little fingers generally in registration with the index finger relative to the direction of nail travel. As such, were a nail from a nail gun to be misdirected toward the fingers of a user wearing a glove 100 as described herein, the middle, ring and little fingers, although unarmored themselves, would likely be behind the index finger, relative to the direction of nail travel, so as to be protected from the nail by the armor plates 104A, 104G, 104B, 104H, 104C covering the index finger portion 116 portions 124, 126, 128.

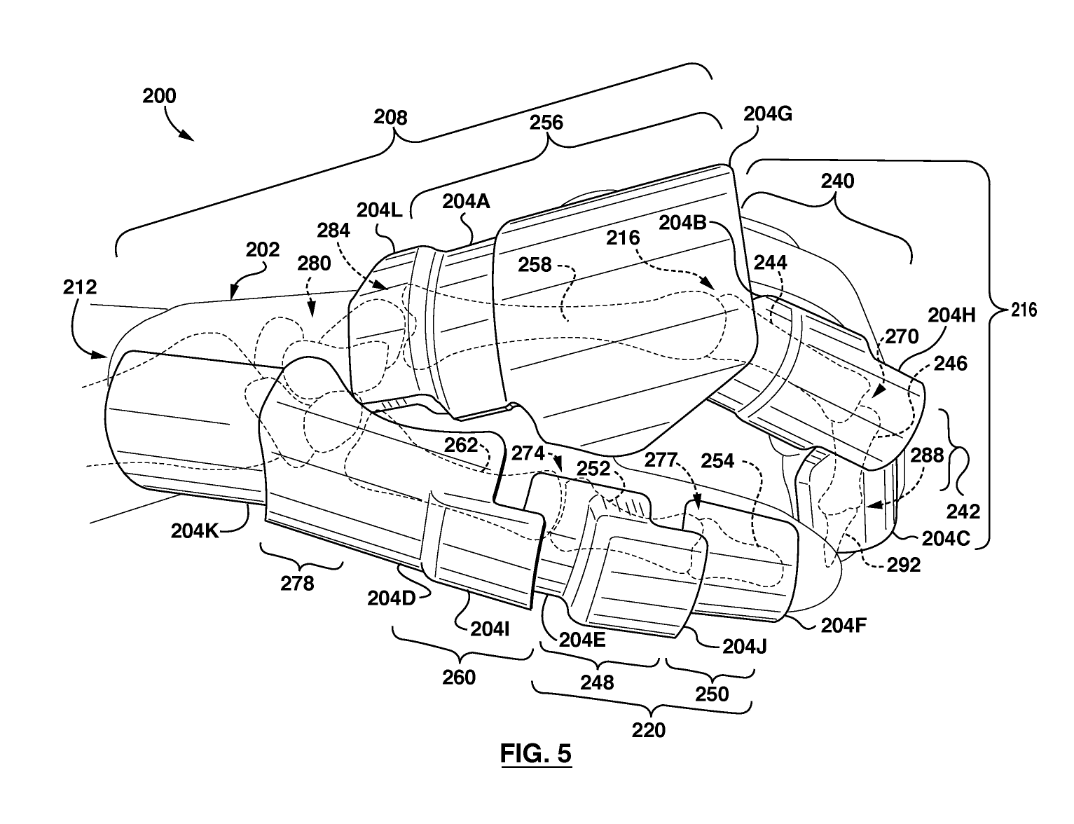

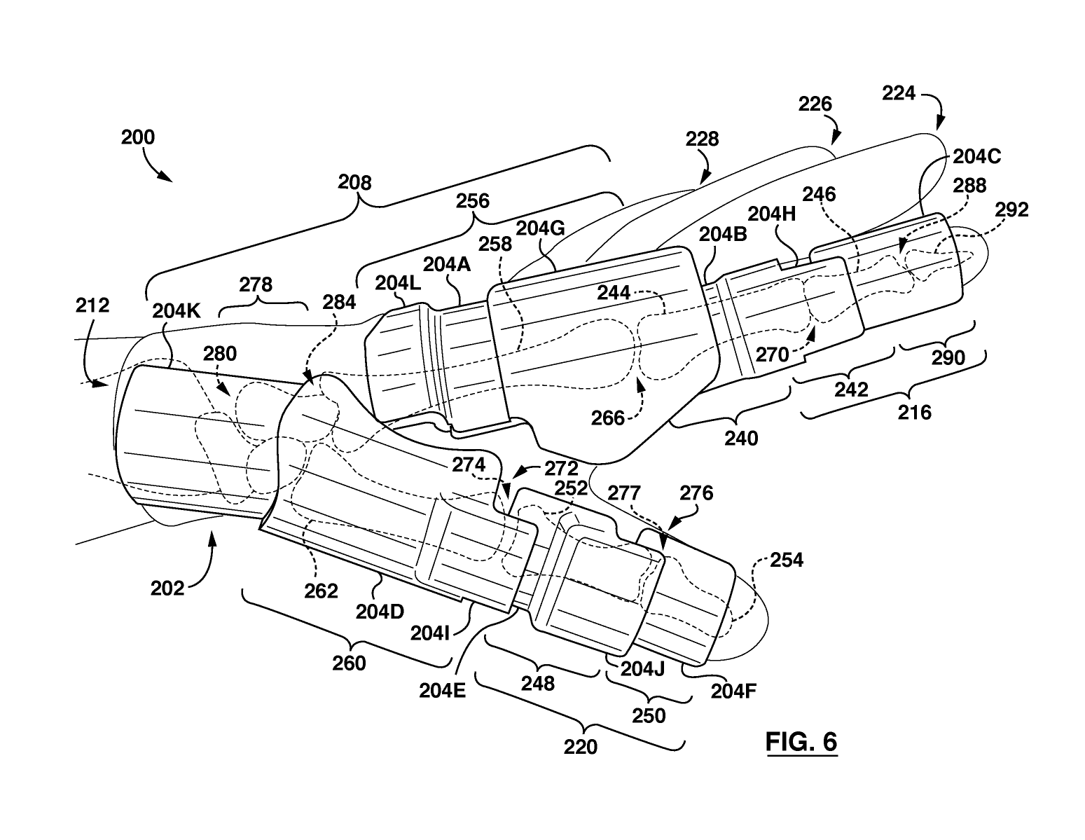

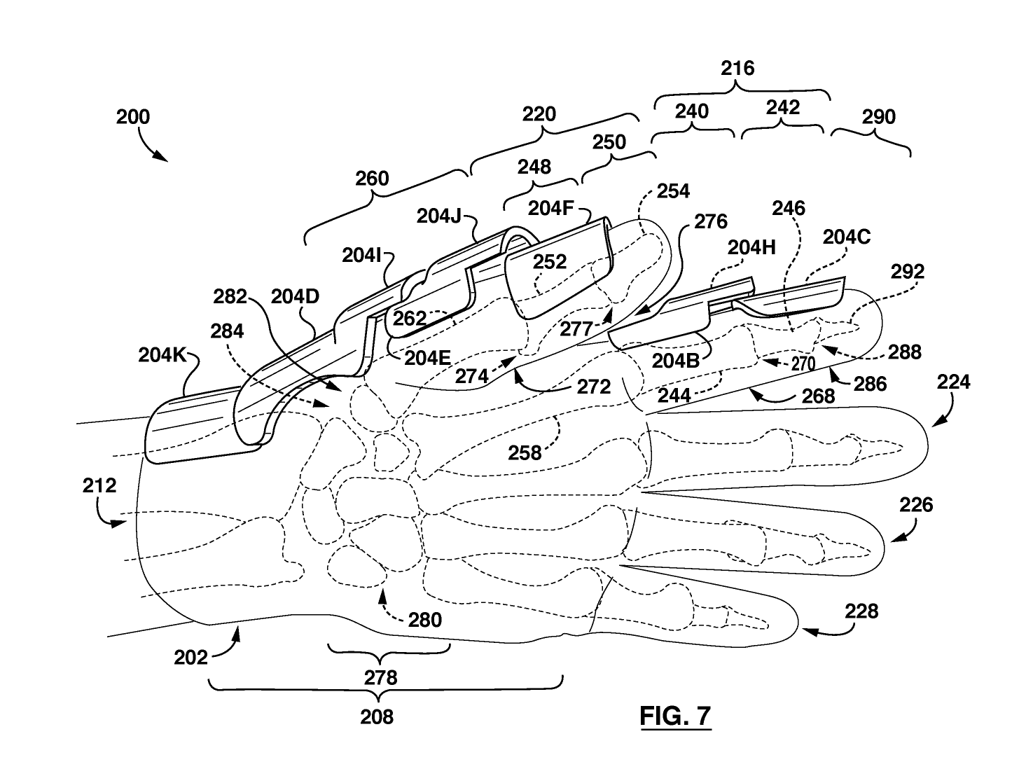

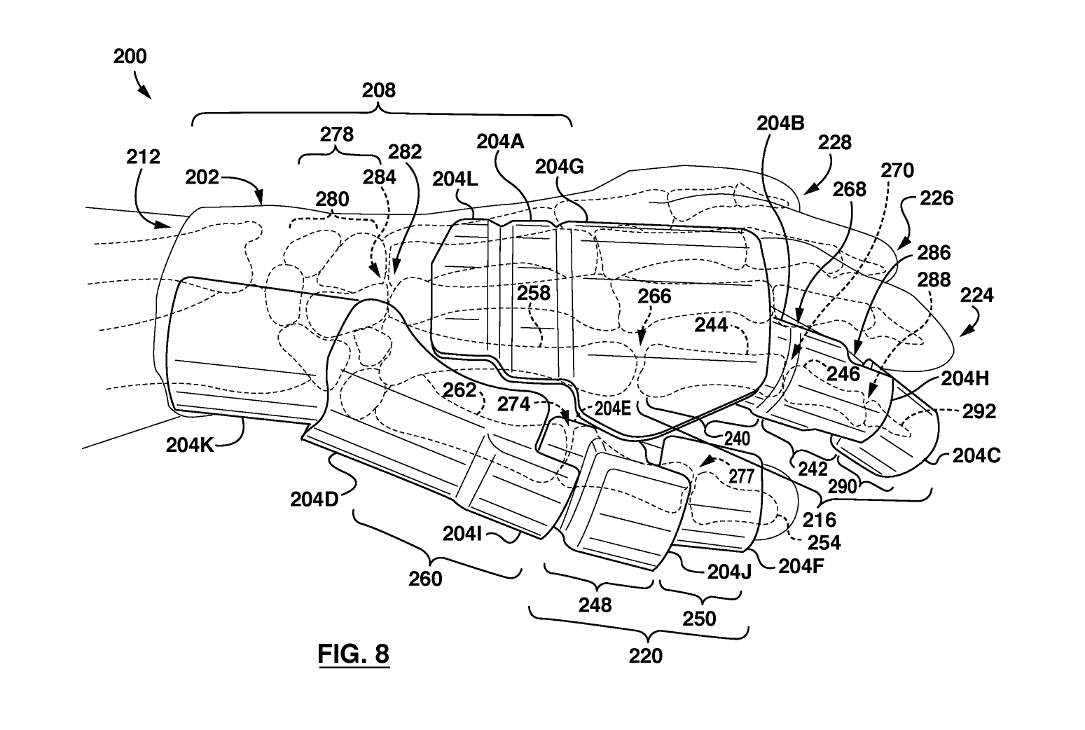

As noted above, in some embodiments some or all of the joint plates may be formed monolithically with other plates. Reference is now made to FIGS. 5 to 8 in which a second exemplary protective glove is indicated generally at reference 200. The second exemplary protective glove 200 is similar to the first exemplary protective glove 100, with like features denoted by like reference numerals except with the prefix “2” instead of “1”. As such, the second exemplary protective glove 200 comprises a flexible base glove 202 and a plurality of discrete, rigid armor plates secured on the base glove 202. The second exemplary protective glove 200 differs from the first exemplary protective glove 100 in that in the second exemplary protective glove 200, the joint plates 204G to 204J and 204L are formed integrally, i.e. monolithically, with other plates.

In particular, in the second exemplary protective glove 200, the index finger metacarpophalangeal joint plate 204G is formed monolithically with the index finger metacarpal plate 204A and extends distally therefrom to overlap the index finger proximal phalanx plate 204G, the index finger proximal interphalangeal joint plate 204H is formed monolithically with the index finger proximal phalanx plate 204B and extends distally therefrom to overlap the index finger middle phalanx plate 204C, the thumb metacarpophalangeal joint plate 204I is formed monolithically with the thumb metacarpal plate 204D and extends distally therefrom to overlap the thumb proximal phalanx plate 204E and the thumb interphalangeal joint plate 204J is formed monolithically with the thumb proximal phalanx plate 204E and extends distally therefrom to overlap the thumb distal phalanx plate 204F. In addition, the carpometacarpal joint plate 204L is formed monolithically with the index finger metacarpal plate 204A and extends proximally therefrom to overlap the carpal plate 204K.

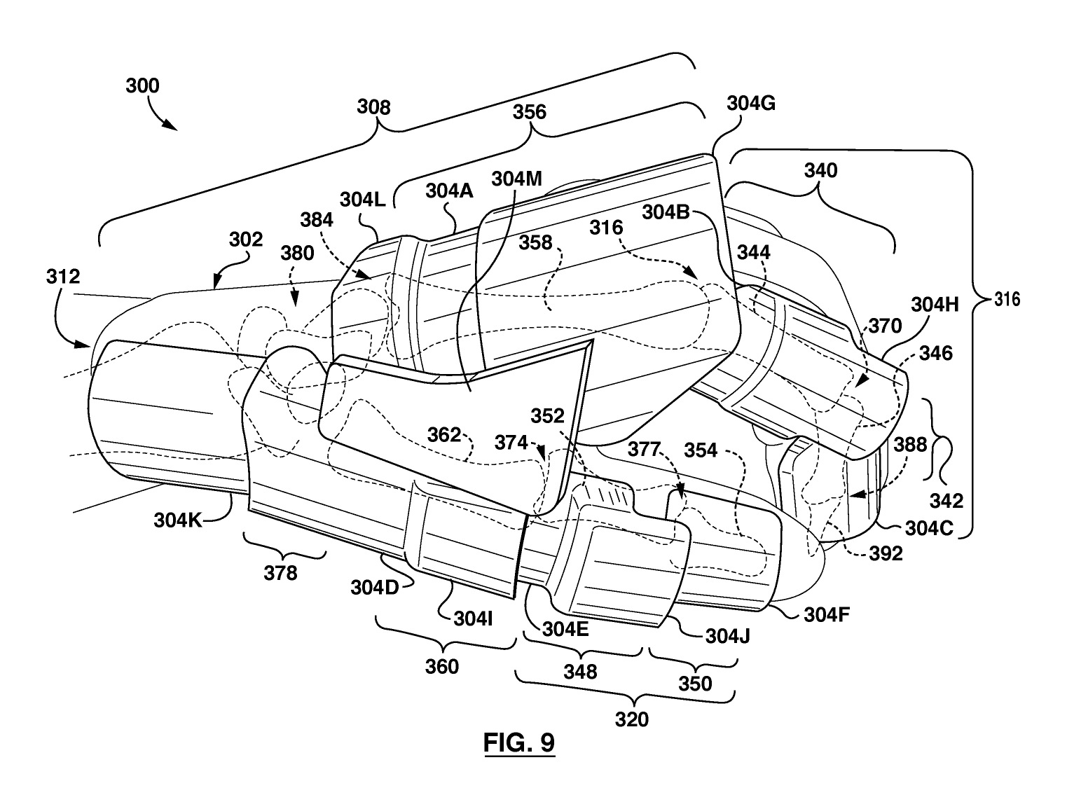

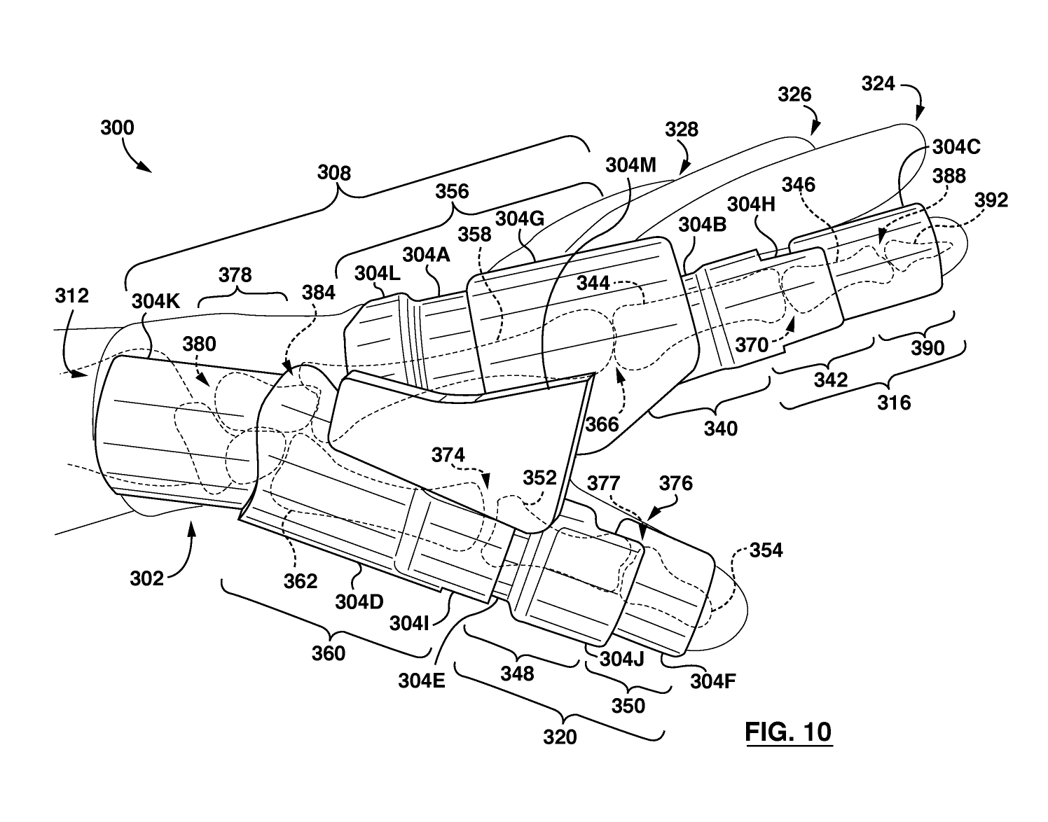

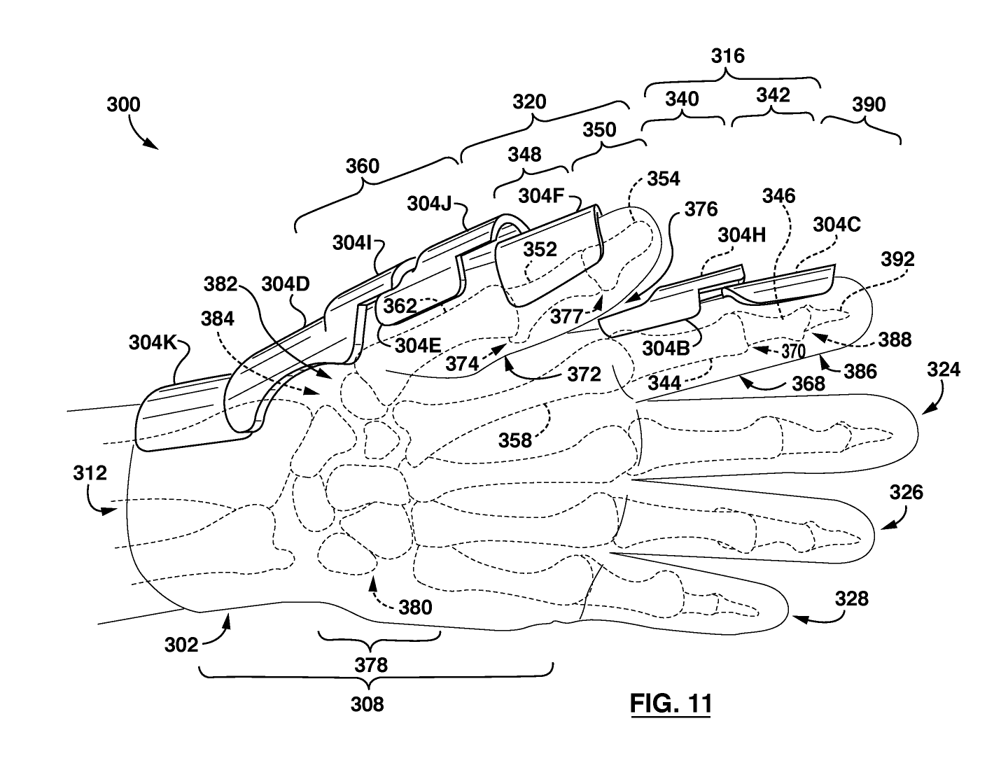

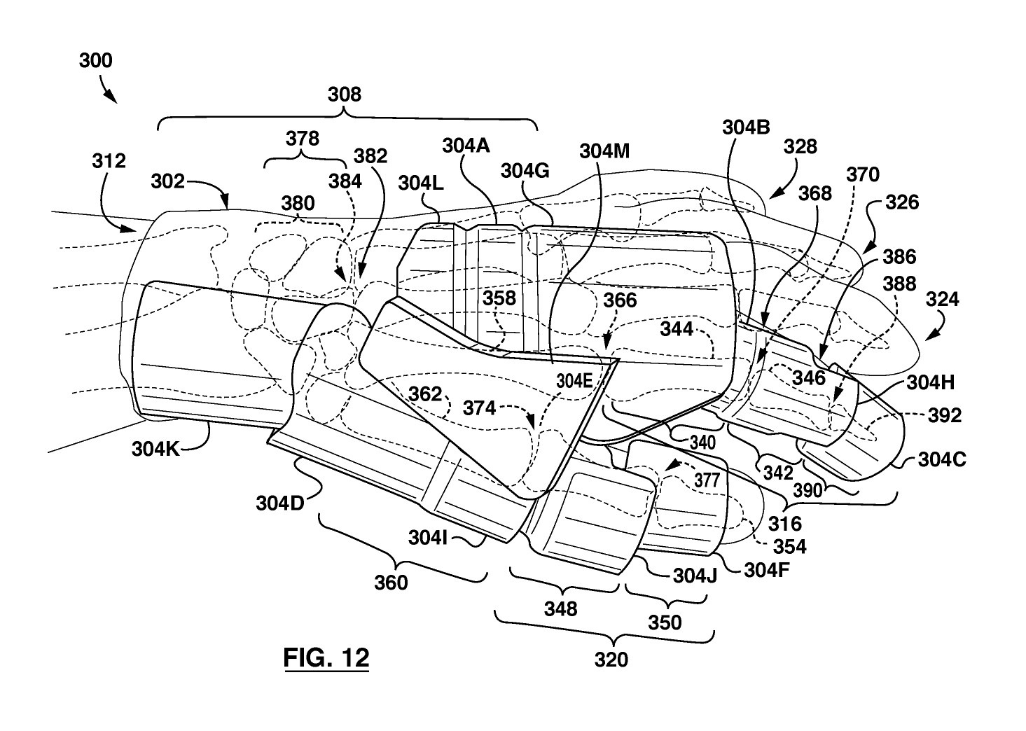

Reference is now made to FIGS. 9 to 12, in which a third exemplary protective glove is indicated generally at reference 300. The third exemplary protective glove 300 is similar to the second exemplary protective glove 200, and comprises a flexible base glove 302 and a plurality of discrete, rigid armor plates secured on the base glove 302, with like features denoted by like reference numerals except with the prefix “3” instead of “2”. Like the second exemplary protective glove 200, in the third exemplary protective glove 300, the joint plates 304G to 304J and 304L are formed integrally, i.e. monolithically, with other plates.

The third exemplary protective glove 300 differs from the second exemplary protective glove 200 in that the third exemplary protective glove 300 is provided with a first dorsal interosseous protective plate 304M that extends from the carpometacarpal joint plate 304L, index finger metacarpal plate 304A and index finger metacarpophalangeal joint plate 304G to overlap the thumb metacarpal plate 304D and thumb metacarpophalangeal joint plate 304I and thereby provide additional protection to the first dorsal interosseous region of a user's hand, i.e. the region between that covered by the carpometacarpal joint plate 304L, index finger metacarpal plate 304A and index finger metacarpophalangeal joint plate 304G and that covered by the thumb metacarpal plate 304D and thumb metacarpophalangeal joint plate 304I. Preferably, the first dorsal interosseous protective plate 304M is formed as part of a monolithic unit that also includes the carpometacarpal joint plate 304L, index finger metacarpal plate 304A and index finger metacarpophalangeal joint plate 304G, although the first dorsal interosseous protective plate 304M may also be formed as a separate piece and secured to the carpometacarpal joint plate 304L, index finger metacarpal plate 304A and/or index finger metacarpophalangeal joint plate 304G.

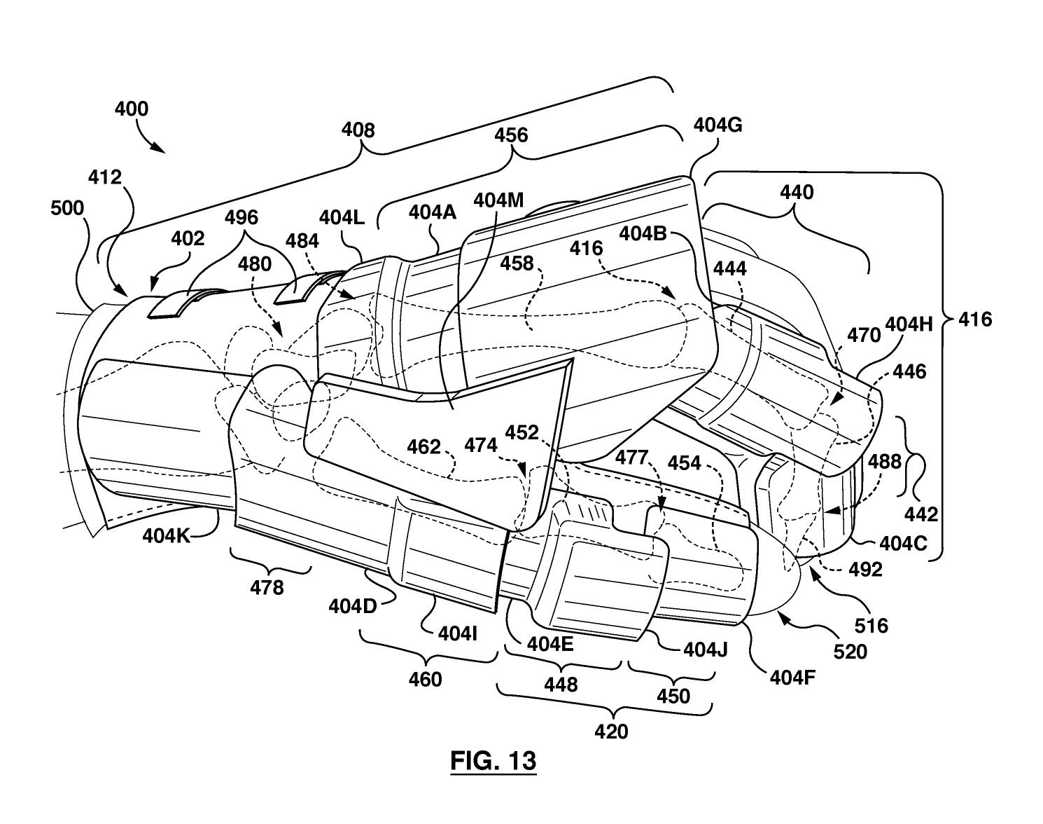

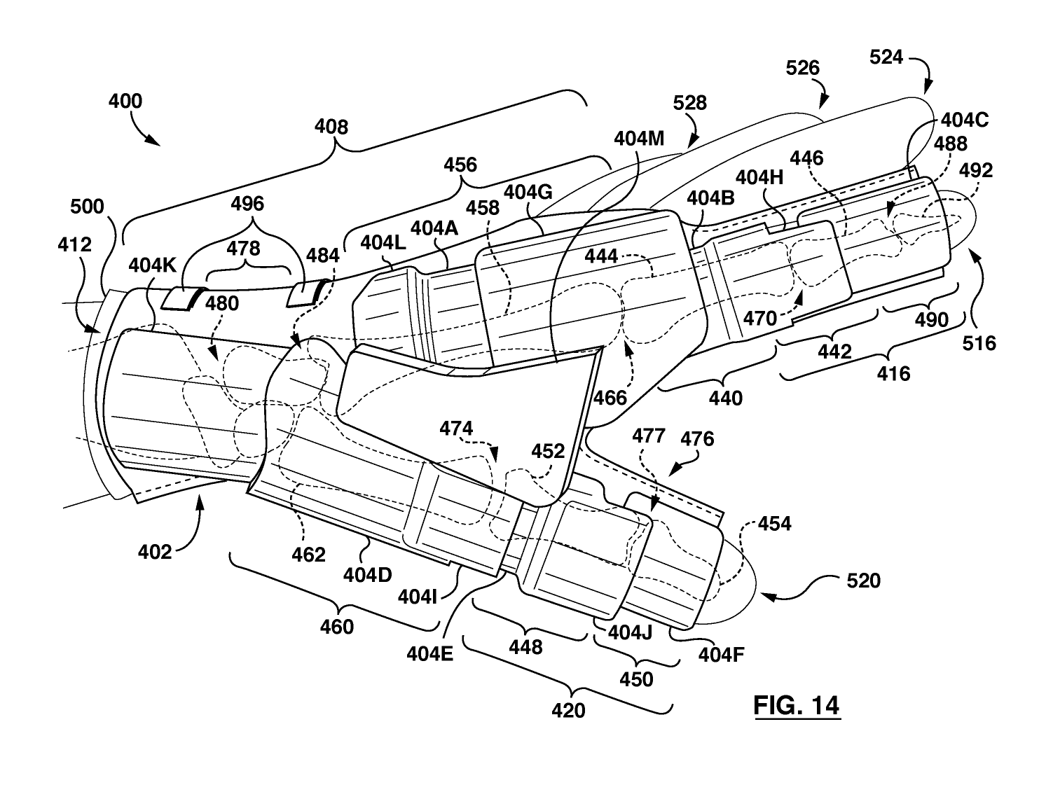

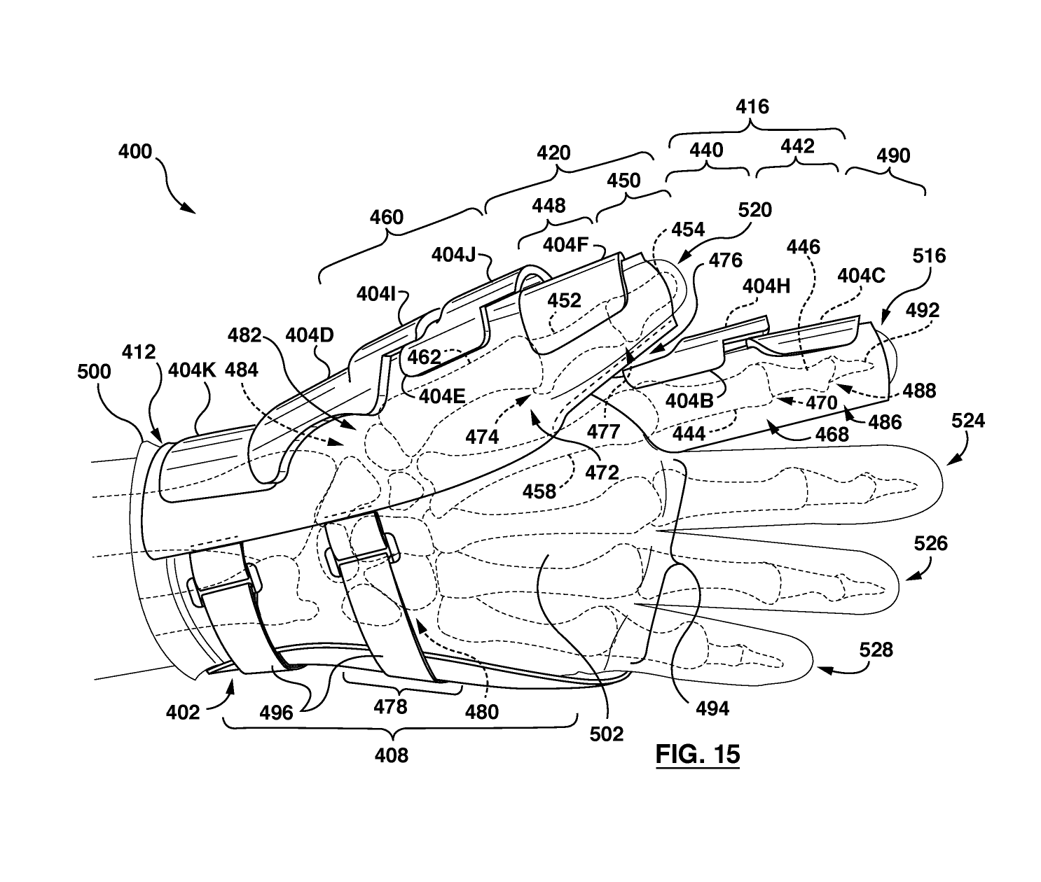

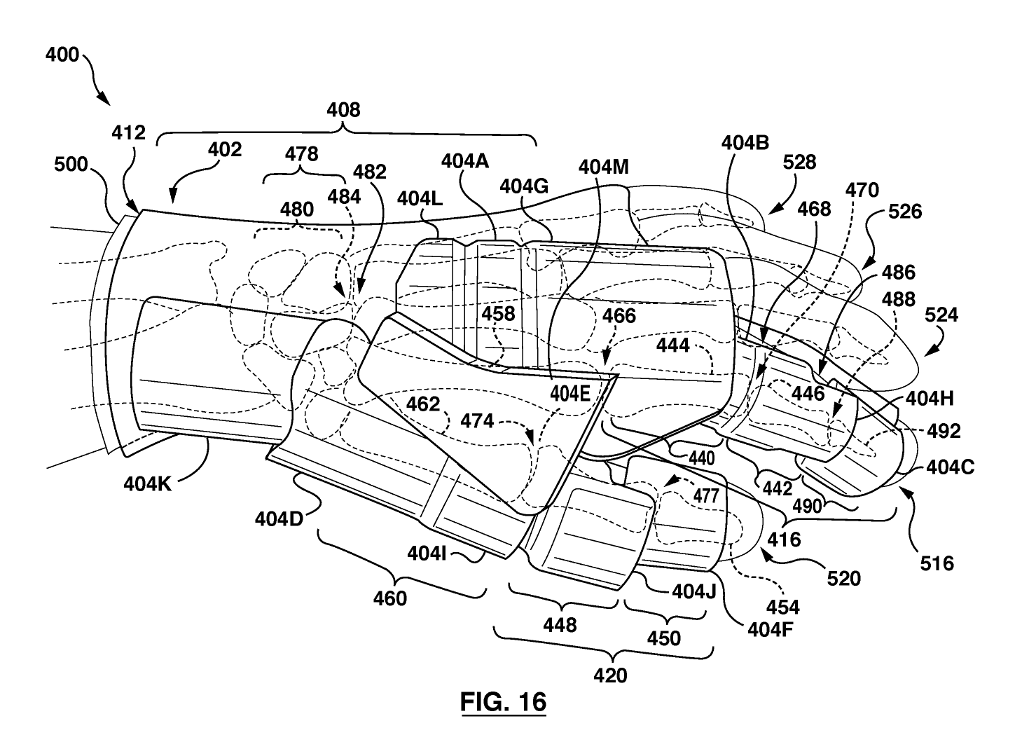

Reference is now made to FIGS. 13 to 17, in which a fourth exemplary protective glove is indicated generally at reference 400. The fourth exemplary protective glove 400 is similar to the third exemplary protective glove 300, and comprises a flexible base glove 402 and a plurality of discrete, rigid armor plates secured on the base glove 402, with like features denoted by like reference numerals except with the prefix “4” instead of “3”.

The fourth exemplary protective glove 400 differs from the third exemplary protective glove 300, and also from the first and second exemplary protective gloves 100, 200, in that the fourth exemplary protective glove 400 is a hand cap style of glove. As such, the fourth exemplary protective glove 400 includes a main portion 408, a distally open index finger portion 416 extending from the main portion 108 and a distally open thumb portion 420 also extending from the main portion 408, but does not include middle, ring and little finger portions and instead has a distal finger aperture 494 through which the middle, ring and little fingers may pass. While the illustrated embodiment shows a single distal finger aperture 494 to accommodate all three of the middle, ring and little fingers, other embodiments may have a single respective aperture for each of the middle, ring and little finger.

As shown in the drawings, the fourth exemplary protective glove 400 is intended to be used in conjunction with, indicated generally by reference 500 and having a proximally open main portion 502 with an index finger portion 516, a thumb portion 520, a middle finder portion 524, a ring finger portion 526 and a little finger portion 528 extending therefrom. The conventional work glove 500 may be of any suitable construction to provide the required protection against cuts, abrasion, etc. depending on the work being done. The fourth exemplary protective glove 400 can be worn over top of a conventional work glove the conventional work glove 500 when using a nail gun to provide additional protection against penetration by nails, and then removed when the nail gun is no longer being used. To facilitate donning and doffing, in the illustrated embodiment the main portion 402 of the fourth exemplary protective glove 400 is of open construction adapted to wrap around a wearer's hand and is provided with adjustable straps 496 (e.g. hook and loop straps) for securing the main portion 402 in a wrapped configuration (i.e. annular or penannular) which forms the wrist opening 412 and the distal finger aperture 494. Other constructions, e.g. a tubular construction of the main portion, are also contemplated. The adjustable hand cap design of the fourth exemplary protective glove 400 also facilitates sharing of a single such glove among multiple workers, which may reduce costs at a worksite where only a single nail gun, staple gun or the like is likely to be in use but may be used by more than one worker.

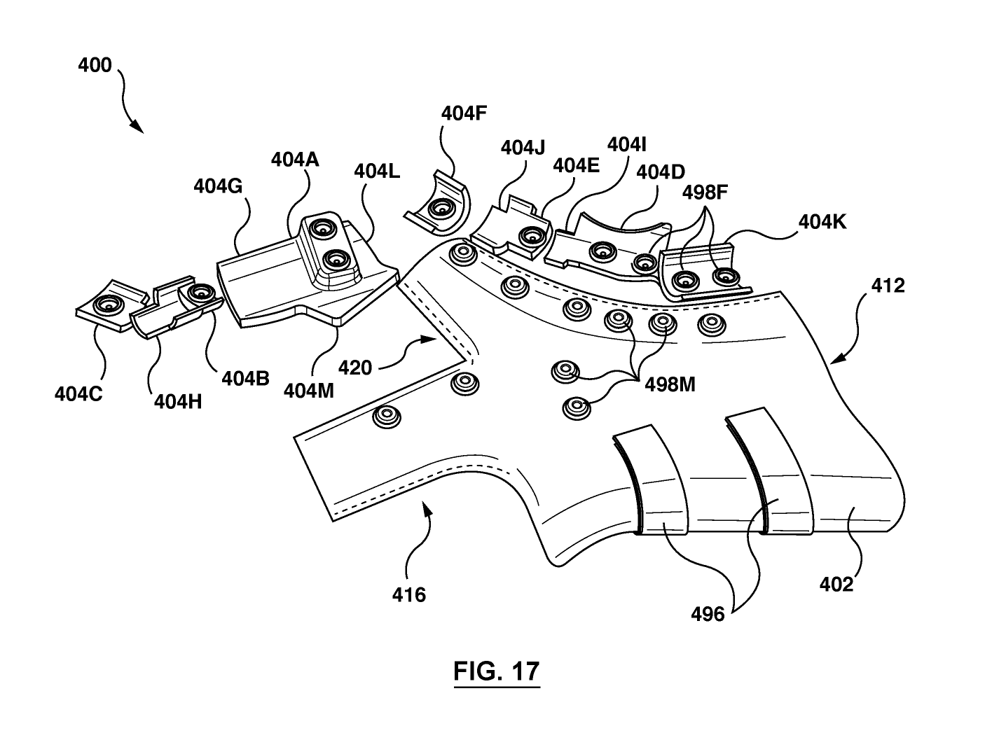

FIG. 17 shows the fourth exemplary protective glove 400 in a flattened, unrolled configuration with its armor plates 404A to 404L dismounted. In the illustrated embodiment, the armor plates 404A to 404L are releasably mounted on the base glove 402 by way of snap fasteners (also known as press studs) comprising a plurality of male fastener portions 498M riveted into the base glove 402 and a plurality of corresponding female fastener portions 498F riveted into certain of the armor plates 404A to 404L. The male fastener portions 498M and the female fastener portions 498F are releasably interengageable with one another. This permits the armor plates 404A to 404L to be dismounted from the base glove 402 for cleaning or replacement of the base glove 402. In addition, in the event that one of the armor plates 404A to 404L deflects a nail, staple or the like, it may be compromised and unsuitable for further use. By making the armor plates 404A to 404L dismountable, only the compromised armor plate (or the integrally formed unit of which it is a part) needs to be replaced, rather than the entire glove. Although this dismountable arrangement is shown in respect of the fourth exemplary protective glove 400, it may be incorporated into other embodiments, such as the first, second and third exemplary protective gloves 100, 200, 300, or others.

The particular positioning and arrangement of armor plates described herein represents merely certain particular exemplary embodiments. Other arrangements of armor plates which protect the portions of the hand that are typically exposed to a nail gun or staple gun, i.e. a radial surface of the main (metacarpal) portion, a radial surface of the index finger portion and a radial surface of the thumb portion, are also contemplated. For example, and without limitation, in other embodiments some joint plates may be integrally formed with other plates while other joint plates are discrete plates.

Certain currently preferred embodiments have been described by way of example. It will be apparent to persons skilled in the art that a number of variations and modifications can be made without departing from the scope of the claims.

What is claimed is:

1. A protective glove, comprising:
a flexible base glove, the base glove adapted to fit over a human hand and including:
a main portion corresponding in position to human metacarpal bones of the human hand and having a wrist opening for inserting the human hand;
at least an index finger portion extending from the main portion, wherein:
the index finger portion corresponds to an index finger of the human hand; and
the index finger portion includes at least an index finger proximal phalanx portion and an index finger middle phalanx portion corresponding in position to an index finger proximal phalanx and an index finger middle phalanx, respectively, of the human hand;
a thumb portion extending from the main portion, wherein:
the thumb portion corresponds to a thumb of the human hand; and
the thumb portion includes a thumb proximal phalanx portion and a thumb distal phalanx portion corresponding in position to a thumb proximal phalanx and a thumb distal phalanx, respectively, of the human hand;
a plurality of discrete armor plates secured on the base glove, wherein the armor plates are positioned on the base glove to cover at least a radial surface of:
the index finger proximal phalanx portion;
the index finger middle phalanx portion;
the thumb proximal phalanx portion;
the thumb distal phalanx portion;
an index finger metacarpal portion of the main portion corresponding in position to a human index finger metacarpal bone of the human hand; and
a thumb metacarpal portion of the main portion corresponding in position to a human thumb metacarpal bone of the human hand.

2. The protective glove of claim 1, wherein:
the base glove includes middle, ring and little finger portions; and
the armor plates leave the middle, ring and little finger portions uncovered.

3. The protective glove of claim 1, wherein the armor plates comprise:
an index finger metacarpal plate positioned on the base glove to cover at least the radial surface of the index finger metacarpal portion;
an index finger proximal phalanx plate positioned on the base glove to cover at least the radial surface of the index finger proximal phalanx portion;
an index finger middle phalanx plate positioned on the base glove to cover at least the radial surface of the index finger middle phalanx portion;
a thumb metacarpal plate positioned on the base glove to cover at least the radial surface of the thumb metacarpal portion;
a thumb proximal phalanx plate positioned on the base glove to cover at least the radial surface of the thumb proximal phalanx portion; and
a thumb distal phalanx plate positioned on the base glove to cover at least the radial surface of the thumb distal phalanx portion.

4. The protective glove of claim 3, wherein:
the index finger metacarpal plate and the index finger proximal phalanx plate are spaced apart from one another on either side of an index finger metacarpophalangeal joint portion of the base glove corresponding in position to a human index finger metacarpophalangeal joint;
the index finger proximal phalanx plate and the index finger middle phalanx plate are spaced apart from one another on either side of an index finger proximal interphalangeal joint portion of the base glove corresponding in position to a human index finger proximal interphalangeal joint;
the thumb metacarpal plate and the thumb proximal phalanx plate are spaced apart from one another on either side of a thumb metacarpophalangeal joint portion of the base glove corresponding in position to a thumb metacarpophalangeal joint; and
the thumb proximal phalanx plate and the thumb distal phalanx plate are spaced apart from one another on either side of a thumb interphalangeal joint portion of the base glove corresponding in position to a thumb interphalangeal joint.

5. The protective glove of claim 4, wherein the armor plates further comprise:
an index finger metacarpophalangeal joint plate secured on the base glove at the index finger metacarpophalangeal joint portion thereof to cover at least the radial surface of the index finger metacarpophalangeal joint portion;
an index finger proximal interphalangeal joint plate secured on the base glove at the index finger proximal interphalangeal joint portion thereof to cover at least the radial surface of the index finger proximal interphalangeal joint portion;
a thumb metacarpophalangeal joint plate secured on the base glove at the thumb metacarpophalangeal joint portion thereof to cover at least the radial surface of the thumb metacarpophalangeal joint portion; and
a thumb interphalangeal joint plate secured on the base glove at the thumb interphalangeal joint portion thereof to cover at least the radial surface of the thumb interphalangeal joint portion.

6. The protective glove of claim 5, wherein:
the index finger metacarpophalangeal joint plate, the index finger proximal interphalangeal joint plate, the thumb metacarpophalangeal joint plate and the thumb interphalangeal joint plate are discrete plates;
and wherein:
the index finger metacarpophalangeal joint plate overlaps the index finger proximal phalanx plate and the index finger metacarpal plate;
the index finger proximal interphalangeal joint plate overlaps the index finger proximal phalanx plate and the index finger middle phalanx plate;
the thumb metacarpophalangeal joint plate overlaps the thumb proximal phalanx plate and the thumb metacarpal plate; and
the thumb interphalangeal joint plate overlaps the thumb proximal phalanx plate and the thumb distal phalanx plate.

7. The protective glove of claim 6, wherein:
the index finger metacarpophalangeal joint plate is secured to the index finger metacarpal plate;
the index finger proximal interphalangeal joint plate is secured to the index finger proximal phalanx plate;
the thumb metacarpophalangeal joint plate is secured to the thumb metacarpal plate; and
the thumb interphalangeal joint plate is secured to the thumb proximal phalanx plate.

8. The protective glove of claim 5, wherein:
the index finger metacarpophalangeal joint plate is formed monolithically with the index finger metacarpal plate and extends distally therefrom to overlap the index finger proximal phalanx plate;
the index finger proximal interphalangeal joint plate is formed monolithically with the index finger proximal phalanx plate and extends distally therefrom to overlap the index finger middle phalanx plate;
the thumb metacarpophalangeal joint plate is formed monolithically with the thumb metacarpal plate and extends distally therefrom to overlap the thumb proximal phalanx plate; and
the thumb interphalangeal joint plate is formed monolithically with the thumb proximal phalanx plate and extends distally therefrom to overlap the thumb distal phalanx plate.

9. The protective glove of claim 5, further comprising:
a carpal plate positioned on the base glove to cover at least a radial surface of a carpal portion of the main body of the base glove corresponding in position to a human carpal bone assembly;
wherein the carpal plate and the index finger metacarpal plate are spaced apart from one another on either side of an index finger carpometacarpal joint portion of the base glove corresponding in position to a human index finger carpometacarpal joint.

10. The protective glove of claim 9, wherein the carpal plate extends proximally beyond the carpal portion of the main body of the base glove.

11. The protective glove of claim 9, further comprising:
a carpometacarpal joint plate secured on the base glove at the index finger carpometacarpal joint portion thereof to cover at least the radial surface of the index finger carpometacarpal joint portion.

12. The protective glove of claim 11, wherein:
the carpometacarpal joint plate is a discrete plate; and
the carpometacarpal joint plate overlaps the carpal plate and the index finger metacarpal plate.

13. The protective glove of claim 11, wherein the carpometacarpal joint plate is secured to the index finger metacarpal plate.

14. The protective glove of claim 11, wherein the carpometacarpal joint plate is formed integrally with the index finger metacarpal plate and extends proximally therefrom to overlap the carpal plate.

15. The protective glove of claim 11, wherein:
the thumb metacarpal plate overlaps the carpal plate, and
the carpometacarpal joint plate further overlaps the thumb metacarpal plate.

16. The protective glove of claim 11, wherein the index finger proximal phalanx plate, the index finger middle phalanx plate, the thumb proximal phalanx plate, the thumb distal phalanx plate, the index finger metacarpal plate, the thumb metacarpal plate, the index finger proximal interphalangeal joint plate, the index finger metacarpophalangeal joint plate, the thumb interphalangeal joint plate, the thumb metacarpophalangeal joint plate, the carpal plate and the carpometacarpal joint plate are curved to accommodate curvature of the human hand.

17. The protective glove of claim 16, wherein:
the index finger proximal phalanx plate curves dorsally to cover a radial side of a dorsal surface of the index finger proximal phalanx portion of the base glove;
the index finger middle phalanx plate curves dorsally to cover a radial side of a dorsal surface of the index finger middle phalanx portion of the base glove;
the thumb proximal phalanx plate curves dorsally to cover a radial side of a dorsal surface of the thumb proximal phalanx portion of the base glove; and
the thumb distal phalanx plate curves dorsally to cover a radial side of a dorsal surface of the thumb distal phalanx portion of the base glove.

18. The protective glove of claim 17, wherein:
the index finger metacarpal plate curves dorsally to cover a radial side of a dorsal surface of the index finger metacarpal portion of the base glove; and
the thumb metacarpal plate curves dorsally to cover a radial side of a dorsal surface of the thumb metacarpal portion of the base glove.

19. The protective glove of claim 18, wherein:
the index finger proximal interphalangeal joint plate curves dorsally to cover a radial side of a dorsal surface of the index finger proximal interphalangeal joint portion of the base glove;
the index finger metacarpophalangeal joint plate curves dorsally to cover a radial side of a dorsal surface of the index finger metacarpophalangeal joint portion of the base glove;
the thumb interphalangeal joint plate curves dorsally to cover a radial side of a dorsal surface of the thumb interphalangeal joint portion of the base glove; and
the thumb metacarpophalangeal joint plate curves dorsally to cover a radial side of a dorsal surface of the thumb metacarpophalangeal joint portion of the base glove.

20. The protective glove of claim 19, wherein:
the carpal plate curves dorsally to cover a radial side of a dorsal surface of the carpal portion of the base glove; and
the carpometacarpal joint plate curves dorsally to cover a radial side of a dorsal surface of the carpometacarpal joint portion of the base glove.

21. The protective glove of claim 3, wherein:
the index finger portion of the base glove further comprises:
an index finger distal interphalangeal joint portion corresponding in position to an index finger distal interphalangeal joint of a human hand; and
an index finger distal phalange portion corresponding in position to an index finger distal phalange of a human hand;
and wherein the index finger middle phalanx plate extends distally beyond the index finger distal interphalangeal joint portion to cover at least a radial surface of a proximal end of the distal phalange portion.

22. The protective glove of claim 1, wherein the armor plates leave at least fifty percent of an outer surface of the base glove uncovered.

23. The protective glove of claim 1, wherein the armor plates leave at least sixty percent of an outer surface of the base glove uncovered.

24. The protective glove of claim 1, wherein the armor plates leave at least seventy percent of an outer surface of the base glove uncovered.

25. The protective glove of claim 1, wherein the main portion of the base glove has at least one distal finger aperture through which middle, ring and little fingers may pass.

26. The protective glove of claim 1, wherein:
the main portion the base glove is of open construction adapted to wrap around a wearer's hand and is provided with adjustable straps for securing the main portion in a wrapped configuration; and;
when in the wrapped configuration, the main portion of the base glove forms the wrist opening and further forms a single distal finger aperture opposite the wrist opening and through which middle, ring and little fingers may pass.

27. A protective glove, comprising:
a main portion having a wrist opening for inserting a human hand;
an index finger portion extending from the main portion;
a thumb portion extending from the main portion; and
a plurality of articulated armor plates disposed at least along:
a radial surface of the main portion;
a radial surface of the index finger portion; and
a radial surface of the thumb portion.

28. The protective glove of claim 27, wherein the armor plates leave at least fifty percent of an outer surface of the glove exposed.

29. The protective glove of claim 28, wherein the index finger portion is one of four finger portions extending from the main portion.

30. The protective glove of claim 27, wherein the armor plates curve dorsally to cover at least:
a radial side of a dorsal surface of the main portion;
a radial side of a dorsal surface of the index finger portion; and
a radial side of a dorsal surface of the thumb portion.
